(19) United States
(12) Patent Application Publication
(10) Pub. No.: US 2011/0310056 A1
(43) Pub. Date: Dec. 22, 2011

(54) ELECTRONIC BLACKBOARD

(75) Inventor: YIH CHANG, NEW TAIPEI CITY (TW)

(73) Assignee: AROLLTECH CO., LTD., Grand Cayman (KY)

(21) Appl. No.: 13/159,790

(22) Filed: Jun. 14, 2011

(30) Foreign Application Priority Data
Jun. 18, 2010 (TW) 099211571

(51) Int. Cl. G06F 3/041; G06F 3/044

(52) U.S. Cl. 345/174; 345/173

(57) ABSTRACT

An electronic blackboard comprises an addressable light-emitting board and a touch panel. The touch panel is stacked on the surface of the addressable light-emitting board. The touch panel includes a plurality of sensing areas arranged in an array, and the addressable light-emitting board includes a plurality of light-emitting areas corresponding to the sensing areas. When one of the sensing areas generates a sensing signal by a finger or pen, the corresponding light-emitting area is lit and therefore creates clear white trace on a black background to become an electronic blackboard.

### BACKGROUND OF THE INVENTION

1. Technical Field

The present invention relates to an electronic blackboard, and more particularly, to a large area display with touch panel configured to demonstrate instant handwriting or drawing.

2. Background

The optical or electronic whiteboards currently adapted in classes or conference rooms retain users' handwriting on a scrollable drawing white board via a pen or marker. The portion on which the user writes is scrolled to the left while printing. Utilizing the large-scale optical scanner on the left, the optical whiteboard saves the handwriting into the control board and then proceeds to the printing process. However, the high cost of the scrolling device and the large-scale optical scanner limits the conventional optical whiteboard to high-priced applications and thus are difficult to popularize. Moreover, the conventional optical whiteboard cannot be connected to a computer. For those users who want to save notes from the discussion to a computer and make further use of the information, the conventional optical whiteboard can only be operated as a stand-alone machine and cannot fulfill users' expectation.

In light of the preceding background, U.S. Pat. No. 6,831,771 discloses a modified electronic whiteboard using an electrophoretic display. The modified whiteboard includes two insulating substrates and a display grid array sandwiched between the substrates, wherein at least one substrate is transparent. The display grid is filled with electrophoresis fluid, in which the charged particles are dispersed in a solvent or a mixture thereof. The solvent or the mixture thereof may include contrast coloring agents, namely dyes or pigment. Although the modified whiteboard may resolve the aforementioned problems of storage and transmission of whiteboard notes, in order to manifest the black handwriting, the white background does not allow a viewer to clearly see the handwriting with typical distance in the class or conference room due to the low contrast of black trace in a white background. Compared to a conventional blackboard, on which the white handwriting trace on a black background is easy to read, the modified whiteboard of the above disclosure is less ideal.

U.S. patent pre-grant publication No. 2009/0256823 discloses a display resembling an electronic blackboard. The display device is configured to have both a movable transparent electrode and a fixed transparent electrode on a tabular waveguide. When the transparent electrode is pressed down to contact with the fixed bottom electrode at the specific position, the white light in the waveguide at the corresponding area will emit upward through the contacted electrodes due to the closed refractive index, thereby forming a white-on-black configuration with better visual effect. However, the complex electrode structure design of this display generates low yield, and is also difficult for the large area tabular optical waveguide to evenly propagate the light feeding from the side light source to the entire electronic blackboard surface. The display therefore cannot be applied as a large-scale blackboard.

To sum up, in order to (1) increase the white handwriting clarity on a black background surface with clear visual trace in a distance typically in a class or conference room, (2) simplify the structure, and (3) increase the manufacturing yield, the present invention proposes an electronic blackboard which integrates existing optical display devices and touch sensors.

### SUMMARY

The present invention relates to an electronic blackboard, and more particularly, to a large area display with touch panel configured to demonstrate instant handwriting or drawing. The electronic blackboard integrates existing optical display devices and touch sensors and therefore possesses a simple structure which is easy to manufacture with low cost.

According to one embodiment of the present invention, an electronic blackboard comprises an addressable light-emitting board and a touch panel. The touch panel is stacked on the surface of the addressable light-emitting board. The touch panel contains a plurality of sensing areas arranged in an array, and the addressable light-emitting board contains a plurality of light-emitting areas corresponding to the sensing areas. When one of the sensing areas generates a sensing signal touched by pen or marker, the corresponding light-emitting area is lit and therefore generates a clear visual trace on a black surface.

According to one embodiment of the present invention, the touch panel is a transparent capacitive touch panel or a resistive touch panel.

According to one embodiment of the present invention, the electroluminescence display is an inorganic or organic addressable light-emitting board; and the organic addressable light-emitting board illuminates from the top or from the bottom of the surface.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention are illustrated with the following description and upon reference to the accompanying drawings in which:

FIG. 1A illustrates an electronic blackboard according to one embodiment of present invention;

FIG. 1B illustrates the cross section of an electronic blackboard referring to the embodiment shown in FIG. 1A;

FIG. 2 illustrates the cross section of an electronic blackboard according to another embodiment of present invention;

FIG. 3 illustrates the cross section of an electronic blackboard according to another embodiment of present invention;

FIG. 4 illustrates the cross section of an electronic blackboard according to another embodiment of present invention; and

FIG. 5 illustrates the enlarged view of the sensing electrode shown in FIG. 1.

### DETAILED DESCRIPTION

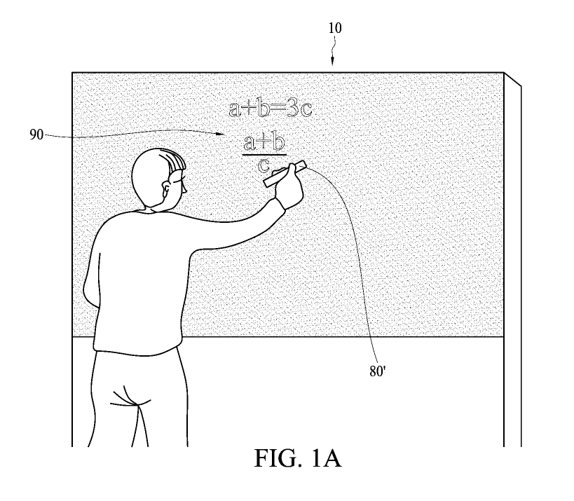

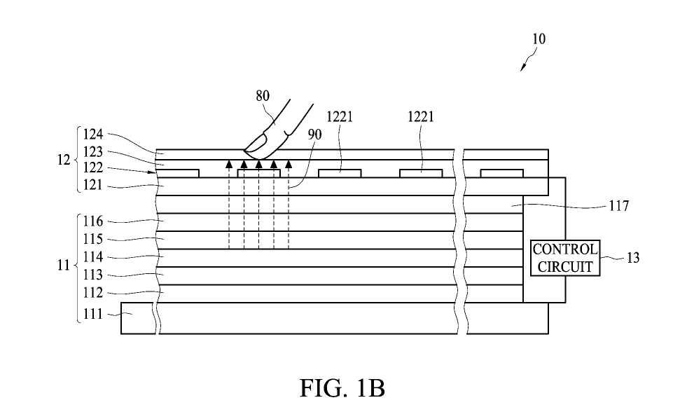

FIG. 1A is an electronic blackboard according to one embodiment of the present invention. A user 90 holds a pen 80′ or puts his finger directly in physical contact with the surface of the electronic blackboard 10. The initial background or untouched region normally exhibits black or dark color. When the pen 80′ hits or contacts the black surface, the surface displays white handwriting trace, as shown in FIG. 1A.

FIG. 1B is a local cross-section view of the electronic blackboard according to the embodiment of FIG. 1A. The electronic blackboard 10 comprises an addressable light-emitting board 11 such as electroluminescence display or addressable light-emitting light source, and a touch panel 12 stacked on the emitting surface of the electroluminescence display or addressable light-emitting light source 11. In this embodiment, the addressable light-emitting board 11 can be, but is not limited to, a small molecule or a polymer based addressable light-emitting board. For example, inorganic electroluminescence display or other displays that utilize electroluminescence can be encompassed in the scope of the present invention. In the embodiment, the organic addressable light-emitting board 11 comprises a first substrate 111, on which an anode 112, a hole transport layer 113, a light-emitting layer 114, an electron transport layer 115, a cathode 116, and a second substrate 117 are stacked in sequence. The stacking structure of the present embodiment is one example; other layers can be added to the stacking structure, such as a hole injection layer, an electron injection layer, etc.

The touch panel 12 in the present embodiment can be, but is not limited to, a capacitive touch panel. For example, a resistive type, an optical type, and a surface acoustic wave type of touch panels are all encompassed in the scope of the present invention. The capacitive touch panel can also have various structures, such as surface and projective capacitive touch panels. The projective capacitive touch panel also have variety of sensing layer structures, such as a single-layered sensing electrode, a double-layered sensing electrode either co-planar or at different layer situated at the same side of the substrate, or a double-layered sensing electrode situated at the opposite side of the substrate. While the present embodiment only demonstrates the capacitive touch panel with single-layered sensing electrode, other touch panel structures are encompassed in the scope of the present invention.

The touch panel 12 of the present embodiment comprises a first substrate 121 (of the touch panel 12), on which a sensing electrode layer 122, an dielectric insulating layer 123, and a second substrate 124 (of the touch panel 12) are positioned in sequence. The sensing electrode layer 122 comprises a plurality of sensing electrodes or sensing regions 1221. The addressable light-emitting board 11 comprises a plurality of light-emitting regions corresponding to those sensing electrodes 1221, as indicated by the dotted lines in the figures. When one of the sensing electrodes 1221 is touched by a finger 80 or a pen 80′, a sensing signal is generated by the control circuit 13 of the touch panel. The electronic blackboard 10 comprises a control circuit 13, which can drive and receive the sensing signal of the touch panel 12, as well as drive the corresponding light-emitting areas and restore the trace for further information processing. The signal will subsequently light up the light-emitting regions corresponding to the sensing electrodes 1221. That is, the light-emitting layer 114 generates light 90, for example white light triggered by the sensing signal and the light penetrates the surface toward the user. Meanwhile, the unlit light-emitting regions still remain dark color, to create a white trace in a black background. Therefore, this generates an electronic blackboard with the white handwriting clarity on a black background surface with clear visual trace in a distance typically in a class or conference room

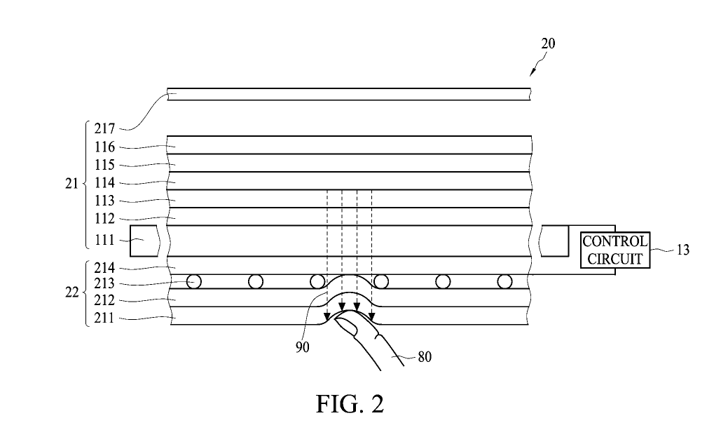

FIG. 2 illustrates a local cross section of an electronic blackboard according to another embodiment of the present invention. The electronic blackboard 20 comprises an addressable light-emitting board 21, and a touch panel 22 stacked on the light-exiting surface of the addressable light-emitting board 21. The addressable light-emitting board 21 comprises a substrate 111, on which an anode 112, a hole transport layer 113, a light-emitting layer 114, an electron transport layer 115, and a cathode 116 are stacked in sequence. The addressable light-emitting board 21 further comprises a protecting cover, encapsulation layers or a protecting substrate 217. The protecting cover, encapsulation layers, or the protecting substrate 217 can, together with the substrate 111, seal the aforementioned stacks 112 to 116. The touch panel 22 can, according to the light travel direction of the addressable light-emitting board 21, be positioned to overlay on the substrate 111 or the protecting cover, encapsulation layers, or protecting substrate 217. The present embodiment positions the touch panel 22 at the outer surface of the substrate 111 because the addressable light-emitting board 21 is the bottom emission electroluminescence display.

The touch panel 22 is a resistive touch panel, comprising a first electrode layer 214, a plurality of space particles 213, a second electrode layer 212, and an insulating layer or a second substrate 211 (of the touch panel 22) on top of first substrate 111. The aforementioned components or layers are formed on the substrate 111 in sequence. The touch panel 22 is directly formed on the substrate 111 in the present embodiment, however, a similar touch panel stack can be formed on an another substrate (for example: 121 in FIG. 1B), and then the touch panel can subsequently be directly laminated to the substrate 111.

When the surface of the second electrode layer 212 is pressed in a predetermined area by a finger 80 or a pen 80′, the second electrode 212 contacts the first electrode layer 214 of the predetermined area, and therefore the control circuit 13 generates a sensing signal, further leading to drive to the illumination of the light-emitting area corresponding to the predetermined area. In other words, the light-emitting layer 114 in the light-emitting region generates light 90, which penetrates the surface toward the user.

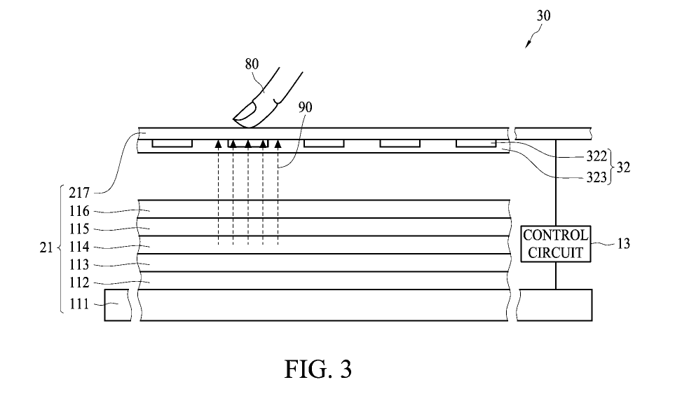

FIG. 3 illustrates a local cross section of the electronic blackboard according to another embodiment of the present invention. The touch panel 32 of the electronic blackboard 30 comprises a sensing electrode layer 322 and an insulating or dielectric layer 323, stacked in sequence at the inner surface of the protecting cover, encapsulation layers, or protecting substrate 217. Hence the touch panel 32 and the protecting cover, encapsulation layers, or protecting substrate 217 can simultaneously act as a seal to the addressable light-emitting board 21 and as a touch panel.

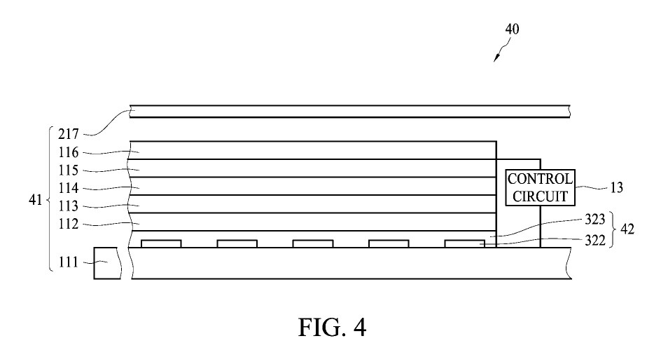

FIG. 4 illustrates a local cross section of the electronic blackboard according to another embodiment of the present invention. The touch panel 42 of the electronic blackboard 40 is first formed on top of the substrate 111 of the addressable light-emitting board 41, followed by the formation of the anode 112, the hole transport layer 113, the light-emitting layer 114, the electron transport layer 115, and the cathode 116. The aforementioned layers are stacked on top of the touch panel 42 in sequence.

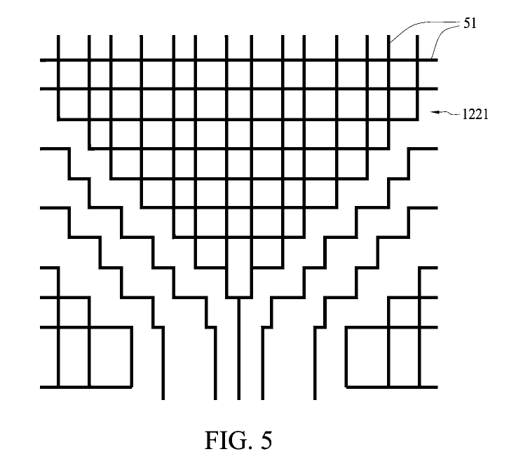

FIG. 5 is an enlarged view of the local layout of the sensing electrode shown in FIG. 1B based on single-layered sensing electrode structure. The sensing electrodes can be comprised of transparent metal oxide, such as indium tin oxide. The sensing electrodes of single-layered sensing structure can also be formed of transparent Graphene, carbon nanotube, or organic conductor. However, to be applicable in the large area electronic blackboard, the sensing electrode 1221 can be comprised of conductive lines 51 made of low resistance materials, such as silver, copper, aluminum, or the alloys thereof, arranged in a mesh or grid network.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An electronic blackboard, comprising:
an addressable light-emitting board; and
a touch panel, comprising a plurality of sensing areas arranged in an array and stacked on a surface of the addressable light-emitting board;
wherein the addressable light-emitting board comprises a plurality of light-emitting areas corresponding to the sensing areas, and when one of the sensing areas generates a sensing signal, the corresponding light-emitting area is lit to form a clear white trace on a black background.

2. The electronic blackboard of claim 1, wherein the touch panel is a transparent capacitive touch panel, a transparent resistive touch panel, an optical touch panel, or a surface acoustic wave touch panel.

3. The electronic blackboard of claim 1, wherein the addressable light-emitting board is an organic electroluminescence display or addressable light-emitting light source or an inorganic electroluminescence display.

4. The electronic blackboard of claim 3, wherein the organic electroluminescence display or addressable light-emitting light source comprises a substrate, an anode, a hole transport layer, a light-emitting layer, an electron transport layer, and a cathode stacked on the substrate in sequence.

5. The electronic blackboard of claim 4, wherein the touch panel is positioned on a surface of the substrate, and an opposite surface of the substrate is in contact with the anode.

6. The electronic blackboard of claim 4, wherein the touch panel is positioned between the anode and the substrate.

7. The electronic blackboard of claim 4, wherein the touch panel is positioned on a surface of the cathode.

8. The electronic blackboard of claim 4, wherein the electroluminescence display or addressable light-emitting light source further comprises a protecting cover, and the protecting cover together with the substrate seals the anode, the hole transport layer, the light-emitting layer, the electron transport layer, and the cathode.

9. The electronic blackboard of claim 8, wherein the touch panel is positioned on a surface of the protecting cover.

10. The electronic blackboard of claim 8, wherein the touch panel is positioned on a surface of the protecting cover, and the surface of the protecting cover on which the touch panel is positioned is adjacent to the cathode.

11. The electronic blackboard of claim 1, wherein each sensing area is a sensing electrode.

12. The electronic blackboard of claim 11, wherein the sensing electrode is conductive lines arranged in a mesh or grid network.

13. The electronic blackboard of claim 1, further comprising a control circuit, wherein the control circuit processes the sensing signal of the touch panel and drives the luminescence of each light-emitting area of the addressable light-emitting board and restore the control and driving information.

14. The electronic blackboard of claim 1, wherein the addressable light-emitting board is a bottom-emission type or top-emission type.

15. The electronic blackboard of claim 1, wherein the addressable light-emitting board is an electroluminescence display or addressable light-emitting light source.
